(19) United States
(12) Patent Application Publication
(10) Pub. No.: US 2020/0321588 A1
(43) Pub. Date: Oct. 8, 2020

(54) STACKED SECONDARY BATTERY AND BAG-LIKE SEPARATOR

(71) Applicant: NEC CORPORATION

(72) Inventors: Kaoru NARITA, Tokyo (JP); Noriyuki TAMURA, Tokyo (JP); Sadanori HATTORI, Tokyo (JP)

(73) Assignee: NEC CORPORATION, Tokyo (JP)

(21) Appl. No.: 16/303,997

(22) PCT Filed: May 19, 2017
(86) PCT No.: PCT/JP2017/018767

§ 371 Date: Nov. 21, 2018

(30) Foreign Application Priority Data
May 26, 2016 (JP) 2016-105071

(51) Int. Cl. H01M 2/18; H01M 2/16; H01M 4/13

(52) U.S. Cl. CPC H01M 2/18; H01M 2004/028; H01M 4/13; H01M 2/1673

(57) ABSTRACT

Provided is a stacked secondary battery with which it is possible to prevent the phenomenon of gas generated by an electrode material or the like inside a cell accumulating between an electrode and a separator, and forming bubbles that cannot readily escape, and with which safety performance at high temperatures can be enhanced. A stacked secondary battery in which a positive electrode and a negative electrode are stacked with a bag-like separator interposed therebetween, wherein one of the positive electrode and the negative electrode is accommodated in the bag-like separator, the other of the positive electrode and the negative electrode is stacked on the bag-like separator accommodating said one electrode, and the bag-like separator has a uniaxial contraction characteristic at high temperatures and has a slit formed in a contraction direction along which the contraction coefficient of the bag-like separator is large.

### TECHNICAL FIELD

The present invention relates to a stacked secondary battery and a bag-like separator, and more particularly, to a cell structure of a stacked secondary battery in which a positive electrode and a negative electrode are stacked with a separator interposed therebetween.

### BACKGROUND ART

As a separator of a stacked secondary battery, one using a bag-like separator is known. In Patent Literature 1 (PTL1), a bag-like shape is first formed by heat-sealing a surrounding portion of two sheets of separators, and in the bag-like separator, a structure is formed in which a positive electrode formed by coating a material on both sides thereof is inserted. Further, in PTL1, a structure in which the bag-like separator including the positive electrode and a negative electrode formed by coating a material on both sides thereof are alternately stacked is assumed.

This bag-like separator has a structure welded by applying heat and pressure to a part of a surrounding portion of two sheets of separators. This structure is advantageous in preventing a phenomenon that, when a cell is exposed to a high-temperature, each separator contracts and each positive electrode is exposed, thus the positive electrode and the negative electrode contact each other and an internal short-circuit occurs, and is advantageous in enhancing safe performance of the cell.

Non Patent Literature 1 (NPL1) also describes a high-temperature characteristic about a separator. Performance of a separator greatly varies depending on presence or absence of a base material or coating of the separator, a coating material, a coating method, or the like. Basically, in order to form an opening through which lithium ions are movable between a positive electrode and a negative electrode through a separator, there is a process of extending (stretching) the separator during a manufacturing process. When the separator is exposed to a high-temperature, contraction occurs mainly in a stretching direction.

As a heat-sealing pattern for forming the bag-like separator described above, various measures have been taken so far. Like in PTL1, a welded portion may be continuously formed except for an area surrounding the separator and a certain side of a tab of a positive electrode, or a non-welded portion may be formed at a location where the welded portion is provided. Further, like in Patent Literature 2 (PTL2), a continuous linear heat-sealed portion and an intermittent heat-sealed portion may be used in combination. Furthermore, like in Patent Literature 3 (PTL3), only four corners may be heat-sealed. In Patent Literature 4 (PTL4), a positive electrode is divided into four pieces, and the divided positive electrodes are separated by heat-sealed portions. With this structure, strength of the bag-like separator can be increased and safe performance thereof can be enhanced.

### CITATION LIST

### Patent Literature

[PTL1] Japanese Laid-Open Patent Application No. 2008-91100
[PTL2] Japanese Patent No. 4,124,972
[PTL3] Japanese Patent No. 3,511,443
[PTL4] Japanese Laid-Open Patent Application No. Hei9-147914

### Non Patent Literature

[NPL1] S. S. Zhang, “A review on the separators of liquid electrolyte Li-ion batteries”, Journal of Power Sources 164, pp. 351-364, 2007.

### SUMMARY OF INVENTION

### Technical Problem

However, the above-described stacked secondary battery has the following issues. The issues of the stacked secondary battery described in the Background Art will be described with reference to the drawings.

As illustrated in FIG. 11, when an interval “s” of a heat-sealed portion 1102 of a separator 1101 is small, bubbles 1160 of gas generated from an active material or the like of a positive electrode 1103 during activation of a cell or during initial charging may accumulate between the positive electrode 1103 and the separator 1101. In particular, there is an issue that, the bubbles 1160 of the generated gas accumulate at a central portion of the electrode and cannot escape, and a gap is formed between the positive electrode 1103 and the separator 1101, thus a battery operation is inhibited and the electrode is non-uniformly activated.

On the contrary, FIG. 12 illustrates a case where an interval of a heat-sealed portion 1202 is wide. Bubbles formed between a positive electrode 1203 and a separator 1201 can readily escape. However, when the separator 1201 contracts in a contraction direction with a high contraction coefficient at a high temperature of 130° C. or more, an outer shape of the separator 1201 is considered to form a shape as indicated by a dashed line 1201-2 in FIG. 12. When such contraction of the separator 1201 occurs, the positive electrode 1203 is exposed and short-circuited with a negative electrode, which is likely to trigger bursting or firing of the cell, or the like. In other words, the structure described in the Background Art illustrated in FIGS. 11 and 12 has an issue in that it is difficult to achieve that a degassing effect is compatible with safe performance of the cell at a high temperature.

A material which is called a lithium-excess positive electrode material and with which a capacity being twice or more than that of the lithium-ion battery described in the Background Art is obtained is expected to be used for a next-generation secondary battery for a long-range electric vehicle, a drone, a robot, or the like. On the other hand, in the case of forming a positive electrode using this material, gas generated from a positive electrode material tends to increase during activation of a cell or during initial charging/discharging, and this issue is significant.

An object of the present invention is to provide a stacked secondary battery and a bag-like separator which are capable of preventing a phenomenon of gas generated by an electrode material or the like inside a cell accumulating between an electrode and a separator, and forming bubbles that cannot readily escape.

### Solution to Problem

To achieve the above-mentioned object, a stacked secondary battery according to the present invention comprises a positive electrode and a negative electrode, being stacked with a bag-like separator interposed therebetween, wherein

one of the positive electrode and the negative electrode is accommodated in the bag-like separator; another of the positive electrode and the negative electrode is stacked on the bag-like separator in which the one electrode is accommodated; and wherein

the bag-like separator has a uniaxial contraction characteristic at a high temperature and includes a slit formed along a contraction direction with a high contraction coefficient.

A bag-like separator according to the present invention used for a stacked secondary battery in which a positive electrode and a negative electrode are stacked, wherein

the bag-like separator has a uniaxial contraction characteristic at a high temperature, and includes a slit formed along a contraction direction with a high contraction coefficient.

### Advantageous Effect of Invention

According to the present invention, it is possible to prevent a phenomenon of gas generated by an electrode material or the like inside a cell of a stacked secondary battery accumulating between an electrode and a separator, and forming bubbles that cannot readily escape.

### BRIEF DESCRIPTION OF DRAWINGS

FIG. 1 is a plan view for explaining a structure of a stacked secondary battery according to a first example embodiment of the present invention.

FIG. 2 is a sectional view taken along a line A-A in FIG. 1.

FIG. 3 is an exploded perspective view for explaining a method for manufacturing the stacked secondary battery according to the first example embodiment of the present invention.

FIG. 4 is an exploded perspective view for explaining a method for manufacturing the stacked secondary battery according to the first example embodiment of the present invention.

FIG. 5 is a plan view for explaining a structure of a stacked secondary battery according to a second example embodiment of the present invention.

FIG. 6 is a plan view for explaining a structure of a stacked secondary battery according to a third example embodiment of the present invention.

FIG. 7 is a plan view for explaining a structure of a stacked secondary battery according to a fourth example embodiment of the present invention.

FIG. 8 is a plan view for explaining a structure of a stacked secondary battery according to a fifth example embodiment of the present invention.

FIG. 9 is a perspective view illustrating a stacked secondary battery according to a sixth example embodiment of the present invention.

FIG. 10 is a sectional view taken along with a line B-B in

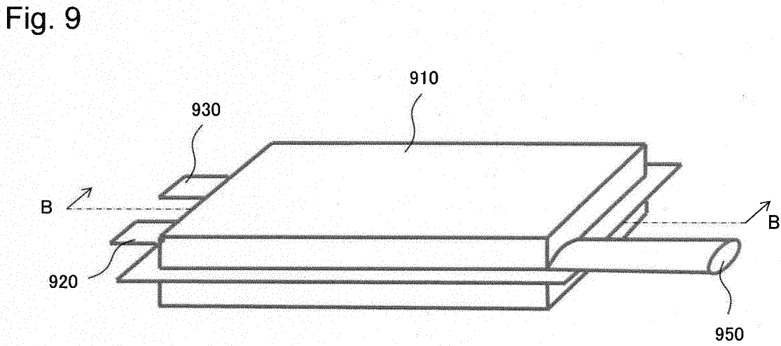

FIG. 9.

FIG. 11 is a plan view of a stacked secondary battery for explaining an issue described in the Background Art.

FIG. 12 is a plan view of a stacked secondary battery for explaining an issue described in the Background Art.

### EXAMPLE EMBODIMENT

Preferred example embodiments of the present invention will be described in detail with reference to the drawings.

### First Example Embodiment

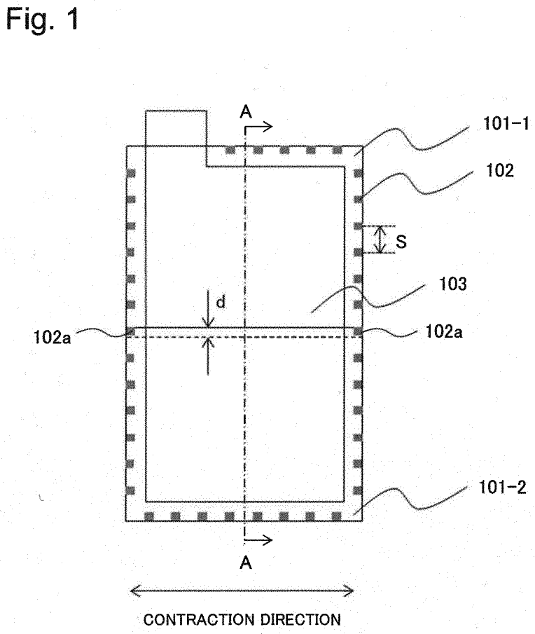

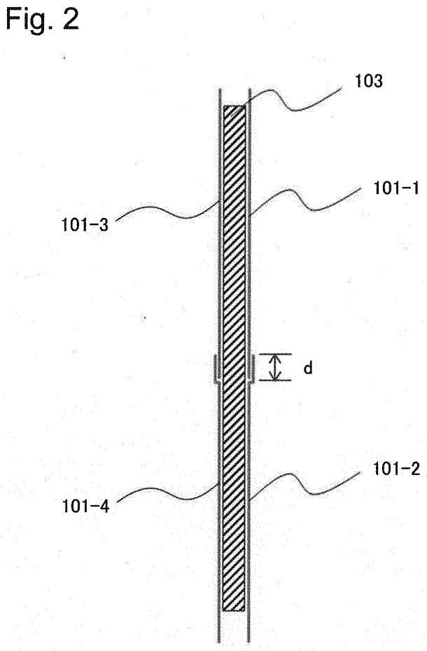

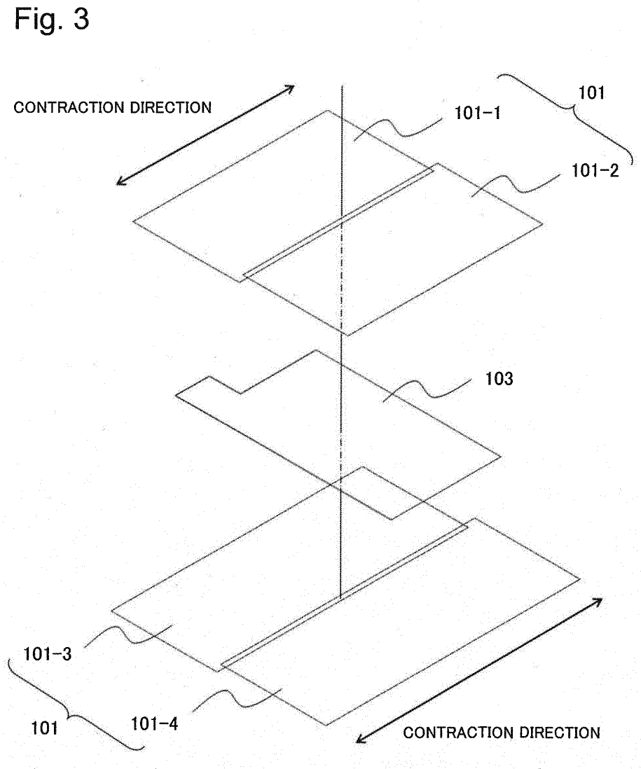

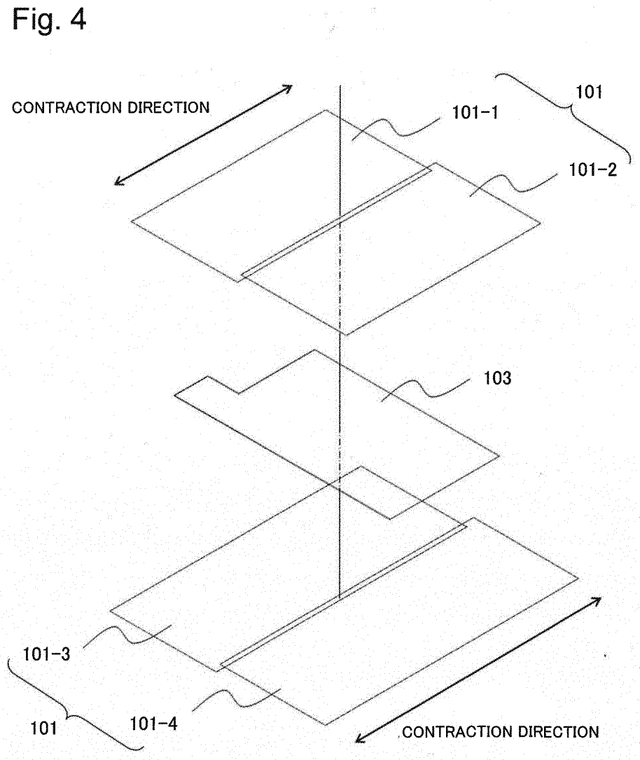

A stacked secondary battery according to a first example embodiment of the present invention will be described. FIG. 1 is a plan view for explaining a structure of the stacked secondary battery according to the first example embodiment of the present invention. FIG. 2 is a sectional view taken along a line A-A in FIG. 1. FIG. 3 is an exploded perspective view for explaining a method for manufacturing the stacked secondary battery according to the first example embodiment of the present invention. FIG. 4 is an exploded perspective view for explaining a method for manufacturing the stacked secondary battery according to the first example embodiment of the present invention.

### [Structure]

The stacked secondary battery according to this example embodiment is a stacked secondary battery having a positive electrode and a negative electrode stacked with a bag-like separator interposed therebetween. This example embodiment illustrates, by way of example, the stacked secondary battery in which the positive electrode, which is one of the positive electrode and the negative electrode, is accommodated in the bag-like separator, and the negative electrode, which is another one of the positive electrode and the negative electrode, is stacked on the bag-like separator in which the positive electrode is accommodated.

FIG. 1 illustrates a positive electrode 103 which is included in a bag-like separator of the stacked secondary battery according to the first example embodiment of the present invention. In FIG. 1, the bag-like separator includes a slit formed along a lateral direction at a central portion of the bag-like separator. As illustrated in FIGS. 1 and 2, the slit of the bag-like separator is formed of a partially overlapping portion between an upper-half portion 101-1 of the bag-like separator and a lower-half portion 101-2 of the bag-like separator. The slit of the bag-like separator is formed in parallel to a contraction direction, as illustrated in FIG. 1, at high temperatures of the bag-like separator.

A distance “d” illustrated in FIGS. 1 and 2 represents a distance corresponding to the overlapping portion of the bag-like separator. Specifically, the distance “d” illustrated in FIGS. 1 and 2 represents a distance corresponding to the overlapping portion between the upper-half portion 101-1 of the bag-like separator and the lower-half portion 101-2 of the bag-like separator. The separators are welded together by heat-sealed portions 102, thereby forming a bag-like separator. Further, heat-sealed portions 102a are provided in the overlapping portion between the upper-half portion 101-1 of the bag-like separator and the lower-half portion 101-2 of the bag-like separator illustrated in FIG. 1. The presence of at least one heat-sealed portion in the overlapping portion between the separators prevents the upper-half portion 101-1 of the separator and the lower-half portion 101-2 of the separator from being separated from each other.

The positive electrode 103 is inserted into the bag-like separator. The positive electrode 103 has a structure in which a positive electrode active material is coated on both sides of a metal foil. When bubbles of gas are generated from the positive electrode active material during activation of the battery or during initial charging/discharging, in the stacked secondary battery according to this example embodiment, the gas readily escapes through the slit formed in the overlapping portion between the separators. Further, a surrounding portion of the bag-like separator is fixed by the heat-sealed portions 102, which prevent the positive electrode 103 from being exposed even when the separator contracts in a contraction direction in a case where a cell is exposed to a high-temperature.

The bag-like separator of the stacked secondary battery according to this example embodiment has a uniaxial contraction characteristic about a contraction axis at high temperatures as indicated by the contraction direction in FIG. 1. This uniaxial contraction characteristic indicates such a contraction characteristic that a high contraction coefficient is included in one direction (contraction axis) at high temperatures, while a contraction coefficient in a direction orthogonal to the contraction axis is small. In the stacked secondary battery according to this example embodiment, the bag-like separator includes a slit formed along a contraction direction with a high contraction coefficient. More specifically, the bag-like separator includes a slit formed in a direction substantially parallel to the contraction axis. Since the slit is formed in parallel to the contraction direction of the separator, the slit is less likely to be opened even when the separators contract, for example, at high temperatures. A structure in which the positive electrode 103 is further less likely to be exposed can be achieved by reducing the interval “s” of the heat-sealed portions 102 illustrated in FIG. 1. In this case, escaping of gas is not impeded because of the presence of the slit.

### [Manufacturing Method]

Next, a method for manufacturing the stacked secondary battery according to the first example embodiment will be described with reference to FIGS. 3 and 4. FIG. 3 illustrates a view of a method for forming a bag-like separator by using a positive electrode and a separator. FIG. 4 illustrates a view of a method for forming a structure in which a bag-like separator including a positive electrode is sandwiched between negative electrodes.

FIG. 3 illustrates a sheet of positive electrode 103, and four sheets of separators 101-1, 101-2, 101-3, and 101-4. The positive electrode 103 has a substantially rectangular shape with a size of about 15 cm vertically and about 7 cm horizontally. The positive electrode 103 has a structure in which a lithium transition-metal oxide is coated respectively on both sides of an aluminum foil having a thickness of about 20 μm with a thickness of about 200 μm. The four sheets of separators 101-1, 101-2, 101-3, and 101-4 are each formed of a porous thin film which is made of polypropylene and has a thickness of about 30 μm. The contraction direction (contraction axis) of each separator at high temperatures (130° C. or higher) is parallel to a short-side direction of the rectangular shape of the positive electrode 103, as illustrated in FIG. 3.

The positive electrode 103 is vertically sandwiched between the two sheets of separators (101-1, 101-2) including an overlapping portion with a distance “d” of about 1 mm and the two sheets of separators (101-3, 101-4) having a similar structure. Further, the separators (101-1 and 101-3, and 101-2 and 101-4) are heat-sealed at a distance slightly outward from the positive electrode 103, thereby forming the bag-like separator. The heat-sealed portions are formed at the interval “s” of about 2 mm with a size of about 1 square millimeter. In this case, at least one heat-sealed portion 102a as illustrated in FIG. 1 is provided in the overlapping portion between the two sheets of separators (101-1, 101-2), or in the overlapping portion between the two sheets of separators (101-3, 101-4). This structure prevents the two sheets of separators (101-1, 101-2) from being separated from each other, and also prevents the two sheets of separators (101-3, 101-4) from being separated from each other.

Next, as illustrated in FIG. 4, a positive-electrode-including bag-like separator 404 which is formed as described above is sandwiched and stacked between negative electrodes 405-1 and 405-2 to thereby form a stacked secondary battery. The negative electrodes 405-1 and 405-2 each have a structure in which graphite is coated respectively on both sides of a copper foil having a thickness of, for example, about 15 μm with a thickness of about 100 μm.

### Advantageous Effects

According to the stacked secondary battery of this example embodiment, it is possible to prevent that gas generated from a positive electrode material during activation of the battery or during initial charging/discharging forms bubbles that cannot be escaped between the electrode and the separator, thus forming a gap, which inhibits motion of (lithium) ions between the positive electrode and the negative electrode. With this structure, the active material formed on the surface of each electrode can be uniformly activated. Accordingly, a uniform operation can be achieved on the surface of each electrode and the original performance of the battery can be exerted. Further, the surrounding portion of the bag-like separator is fixed by heat-sealing, thereby providing a structure in which the positive electrode is less likely to be exposed even when the separators contract at high temperatures, and a short-circuit with the negative electrode is less likely to occur. In other words, it is possible to provide a secondary battery structure capable of sufficiently exerting the original performance of the battery and having a high safe performance at high temperatures.

In the above-described example embodiment, the interval “s” of the heat-sealed portions, the number of slits of each separator, the division of the positive electrode, or the like can be appropriately selected depending on an intended use. Structures intended for this purpose will be described below as second to fifth example embodiments.

### Second Example Embodiment

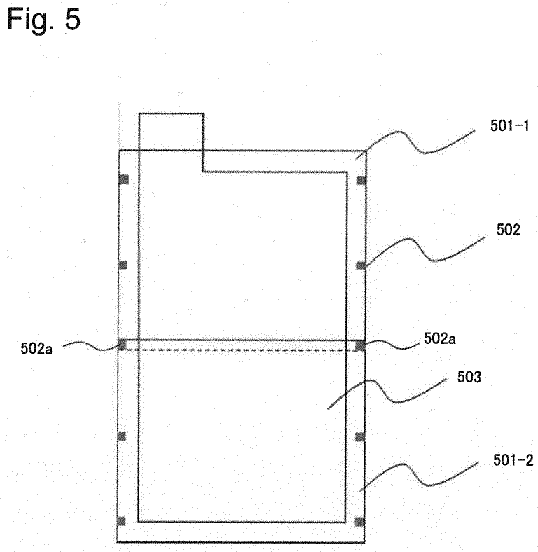

A stacked secondary battery according to a second example embodiment of the present invention will be described. FIG. 5 is a plan view for explaining a structure of the stacked secondary battery according to the second example embodiment of the present invention. FIG. 5 illustrates a positive electrode 503 included in a bag-like separator of the stacked secondary battery according to this example embodiment.

FIG. 5 illustrates an example where, when a separator having a relatively small thermal contraction coefficient at high temperatures is used, the interval “s” is set to be larger than that in the first example embodiment within a range in which the positive electrode is not exposed due to the contraction of the separator at high temperatures. This is an example of enhancing an effect of releasing gas from the periphery of the positive electrode with this structure.

In FIG. 5, like in the first example embodiment, the bag-like separator includes a slit formed along the lateral direction at a central portion. The slit of the bag-like separator is formed of a partially overlapping portion between an upper-half portion 501-1 of the bag-like separator and a lower-half portion 501-2 of the bag-like separator as illustrated in FIG. 5. Like in the first example embodiment, the slit of the bag-like separator is formed along the contraction direction with a high contraction coefficient. More specifically, the slit of the bag-like separator is formed in parallel to the contraction direction of the bag-like separator at high temperatures. The separators are welded by heat-sealed portions 502, thereby forming a bag-like separator. Heat-sealed portions 502a are provided in an overlapping portion between the upper-half portion 501-1 of the bag-like separator and the lower-half portion 501-2 of the bag-like separator illustrated in FIG. 5. The presence of at least one heat-sealed portion in the overlapping portion between the separators prevents the upper-half portion 501-1 of the separator and the lower-half portion 501-2 of the separator from being separated from each other.

According to this example embodiment, it is possible to prevent a phenomenon of gas generated by an electrode material or the like inside a cell of the stacked secondary battery accumulating between the electrode and the separator, and forming bubbles that cannot readily escape, and it is also possible to enhance the safe performance at high temperatures. Further, when a separator having a relatively small thermal contraction coefficient at high temperatures is used, the interval “s” is set to be larger than that in the first example embodiment within a range in which the positive electrode is not exposed due to the contraction of the separator at high temperatures. With this structure, an effect of releasing gas from the periphery of the positive electrode 503 can be enhanced.

### Third Example Embodiment

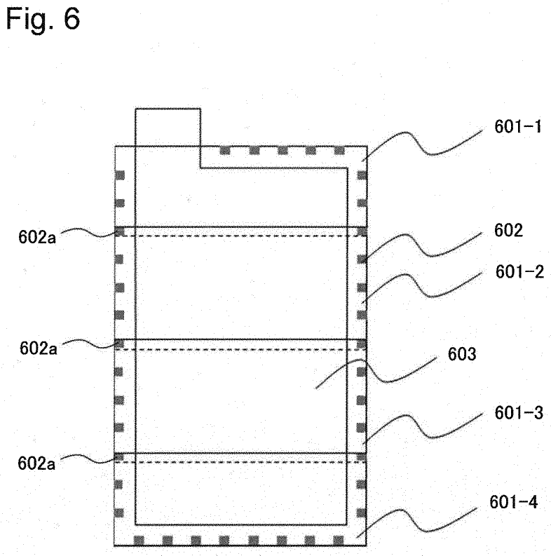

A stacked secondary battery according to a third example embodiment of the present invention will be described. FIG. 6 is a plan view for explaining a structure of the stacked secondary battery according to the third example embodiment of the present invention. FIG. 6 illustrates an example where the number of divisions of the bag-like separator is increased and a large number of slits are formed, thereby enhancing the effect of releasing gas from the central portion of the positive electrode.

In FIG. 6, like in the first example embodiment, the bag-like separator includes a slit formed along the lateral direction. In a bag-like separator according to this example embodiment, a plurality of slits are formed along the lateral direction. In FIG. 6, three slits are formed along the lateral direction. One of the slits of the bag-like separator is formed of a partially overlapping portion between a first portion 601-1 and a second portion 601-2 of the bag-like separator as illustrated in FIG. 6. Another slit of the bag-like separator is formed of a partially overlapping portion between the second portion 601-2 and a third portion 601-3 of the bag-like separator as illustrated in FIG. 6. Further another slit of the bag-like separator is formed of a partially overlapping portion between the third portion 601-3 and a fourth portion 601-4 of the bag-like separator as illustrated in FIG. 6. Each slit of the bag-like separator is formed along the contraction direction with a high contraction coefficient like in the first example embodiment. More specifically, each slit of the bag-like separator is formed in parallel to the contraction direction of the bag-like separator at high temperatures.

The separators are welded together by heat-sealed portions 602, thereby forming a bag-like separator. Heat-sealed portions 602a are provided in the overlapping portion between the first portion 601-1 and the second portion 601-2 of the bag-like separator illustrated in FIG. 6. Further, heat-sealed portions 602a are provided in an overlapping portion between the second portion 601-2 and the third portion 601-3 of the bag-like separator illustrated in FIG. 6. Furthermore, heat-sealed portions 602a are provided in an overlapping portion between the third portion 601-3 and the fourth portion 601-4 of the bag-like separator illustrated in FIG. 6. The presence of the heat-sealed portions 602a in the overlapping portion between the separators prevents respective portions of the separators from being separated from each other.

According to this example embodiment, like in the second example embodiment and the like, it is possible to prevent a phenomenon of gas generated by an electrode material or the like inside a cell of the stacked secondary battery accumulating between the electrode and the separator, and forming bubbles that cannot readily escape, and it is also possible to enhance the safe performance at high temperatures.

Further, according to this example embodiment, the number of divisions of the bag-like separator is increased and a large number of slits are formed, thereby enabling to enhance an effect of releasing gas from the central portion of the positive electrode 603.

### Fourth Example Embodiment

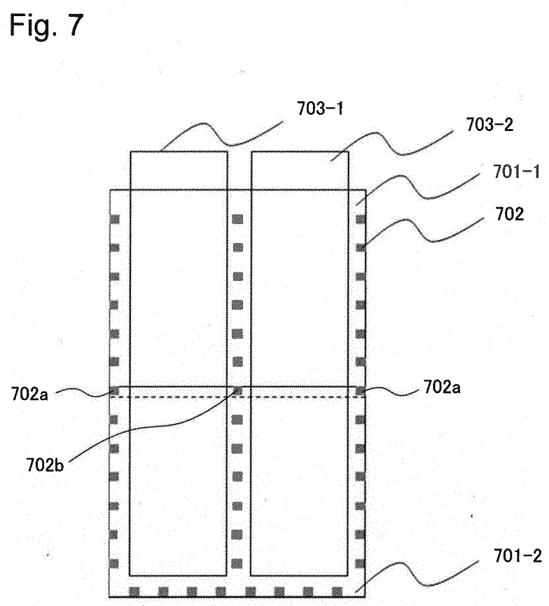

A stacked secondary battery according to a fourth example embodiment of the present invention will be described. FIG. 7 is a plan view for explaining a structure of the stacked secondary battery according to the fourth example embodiment of the present invention. FIG. 7 illustrates an example where the positive electrode is vertically divided into two parts and heat-sealed portions of a separator are also provided between a positive electrode and a positive electrode, thereby enhancing the safe performance in a structure in which the positive electrodes are further less likely to be exposed due to the contraction of the separator at high temperatures.

In FIG. 7, the positive electrode is vertically divided into two parts. In other words, the stacked secondary battery according to this example embodiment includes a positive electrode 703-1 and a positive electrode 703-2 which are obtained by vertically dividing the positive electrode into two parts. In this example embodiment, like in the first example embodiment, the bag-like separator includes a slit formed along the lateral direction at a central portion. The slit of the bag-like separator is formed of a partially overlapping portion between an upper-half portion 701-1 of the bag-like separator and a lower-half portion 701-2 of the bag-like separator as illustrated in FIG. 7. Like in the first example embodiment, the slit of the bag-like separator is formed along the contraction direction with a high contraction coefficient. More specifically, the slit of the bag-like separator is formed in parallel to the contraction direction of the bag-like separator at high temperatures. The separators are welded together by heat-sealed portions 702, thereby forming a bag-like separator. Heat-sealed portions 702a are provided in an overlapping portion between the upper-half portion 701-1 of the bag-like separator and the lower-half portion 701-2 of the bag-like separator illustrated in FIG. 7.

Further, a heat-sealed portion 702b is provided in an overlapping portion between the upper-half portion 701-1 of the bag-like separator and the lower-half portion 701-2 of the bag-like separator between the positive electrode 703-1 and the positive electrode 703-2 which are obtained by vertically dividing the positive electrode into two parts. The presence of at least one heat-sealed portion in the overlapping portion between the separators prevents the upper-half portion 701-1 of the separator and the lower-half portion 701-2 of the separator from being separated from each other. Further, the provision of the heat-sealed portion 702b in the overlapping portion between the separators between the positive electrode 703-1 and the positive electrode 703-2 which are obtained by vertically dividing the positive electrode into two parts further enhances the effect of suppressing the separation.

According to this example embodiment, like in the second example embodiment and the like, it is possible to prevent a phenomenon of gas generated by an electrode material or the like inside a cell of the stacked secondary battery accumulating between the electrode and the separator, and forming bubbles that cannot readily escape, and it is also possible to enhance the safe performance at high temperatures.

Further, according to this example embodiment, the positive electrode is vertically divided and the heat-sealed portions of the separator are provided between the divided positive electrodes, thereby enhancing the safe performance in a structure in which the positive electrodes are further less likely to be exposed due to the contraction of the separator at high temperatures.

### Fifth Example Embodiment

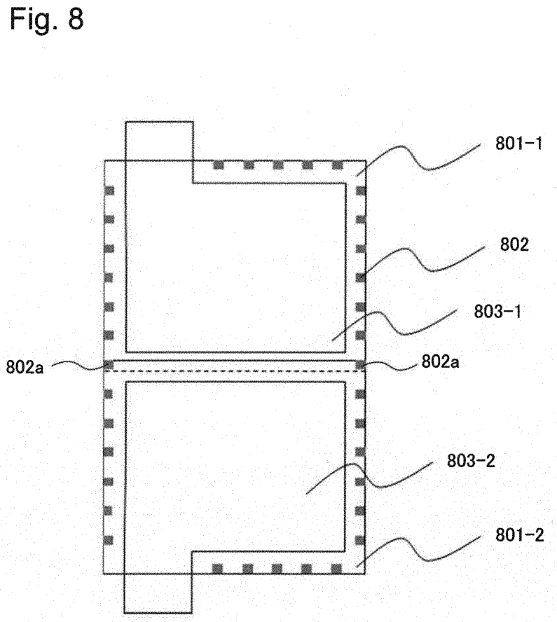

A stacked secondary battery according to a fifth example embodiment of the present invention will be described. FIG. 8 is a plan view for explaining a structure of the stacked secondary battery according to the fifth example embodiment of the present invention. FIG. 8 illustrates that the positive electrode is divided and the divided positive electrodes are arranged in a manner of not overlapping a slit portion. In this case, this is an example of having such a structure that the positive electrodes are less likely to be exposed even when the contraction occurs also in a direction vertical to the contraction direction with a high contraction coefficient at higher temperatures and the slit portion is opened, and enhancing the safe performance.

In FIG. 8, the positive electrode is laterally divided into two parts. In other words, the stacked secondary battery according to this example embodiment includes a positive electrode 803-1 and a positive electrode 803-2 which are obtained by laterally dividing the positive electrode into two parts. In this example embodiment, like in the first example embodiment and the like, the bag-like separator includes a slit formed along the lateral direction at a central portion. As illustrated in FIG. 8, the slit of the bag-like separator is formed of a partially overlapping portion between an upper-half portion 801-1 of the bag-like separator and a lower-half portion 801-2 of the bag-like separator. The slit of the bag-like separator is formed along the contraction direction with a high contraction coefficient, like in the first example embodiment. More specifically, the slit of the bag-like separator is formed in parallel to the contraction direction of the bag-like separator at high temperatures. The separators are welded together by heat-sealed portions 802, thereby forming a bag-like separator. Further, heat-sealed portions 802a are provided in an overlapping portion between the upper-half portion 801-1 of the bag-like separator and the lower-half portion 801-2 of the bag-like separator illustrated in FIG. 8. The presence of the heat-sealed portions in the overlapping portion between the separators prevents the upper-half portion 801-1 of the separator and the lower-half portion 801-2 of the separator from being separated from each other.

In this example embodiment, the positive electrode 803-1 and the positive electrode 803-2 which are obtained by laterally dividing the positive electrode into two parts are arranged so as not to overlap the slit of the bag-like separator.

According to this example embodiment, like in the second example embodiment and the like, it is possible to prevent a phenomenon of gas generated by an electrode material or the like inside a cell of the stacked secondary battery accumulating between the electrode and the separator, and forming bubbles that cannot readily escape, and it is also possible to enhance the safe performance at high temperatures.

Further, according to this example embodiment, the positive electrode is divided and the divided positive electrodes 803-1 and 803-2 are arranged so as not to overlap the slit of the bag-like separator. In other words, the divided positive electrodes 803-1 and 803-2 are arranged so as not to overlap the overlapping portion between the upper-half portion 801-1 of the bag-like separator and the lower-half portion 801-2 of the bag-like separator. With this structure, the positive electrode 803-1 and the positive electrode 803-2 can be made less likely to be exposed even when the contraction occurs also in a direction vertical to the contraction direction with a high contraction coefficient at higher temperatures and the slit portion is opened, and the safe performance can be enhanced.

### Sixth Example Embodiment

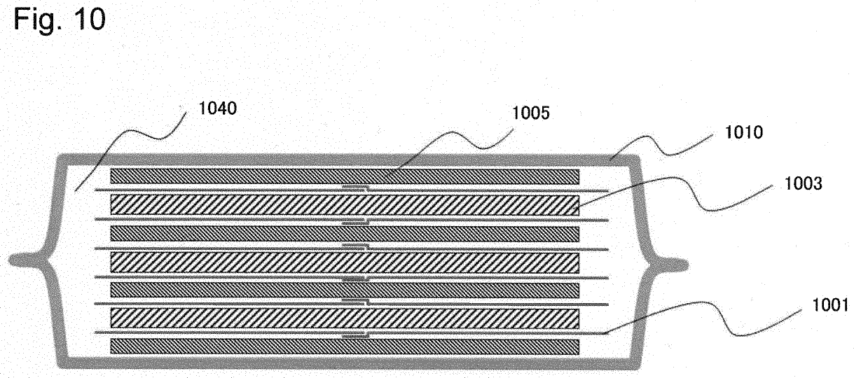

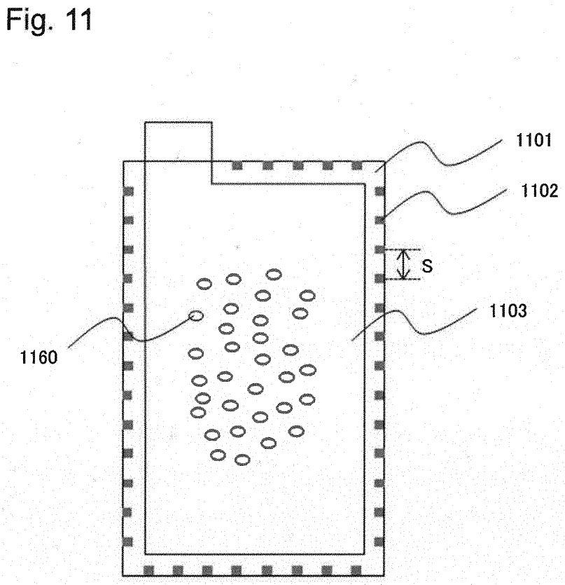

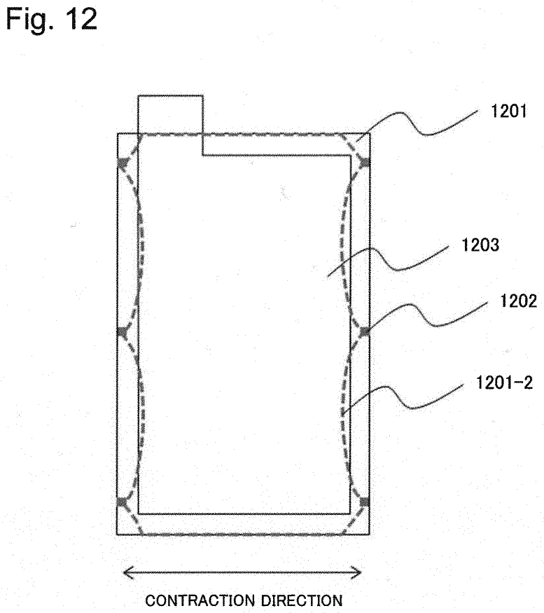

Next, a method for manufacturing a stacked secondary battery according to a sixth example embodiment of the present invention. FIG. 9 is a perspective view illustrating a cell structure of the stacked secondary battery according to the sixth example embodiment of the present invention. FIG. 10 is a sectional view taken along a line B-B in FIG. 9.

First, as illustrated in FIG. 10, a bag-like separator 1001 including a positive electrode 1003 formed by a method described in the manufacturing method according to the first example embodiment and a negative electrode 1005 are alternately stacked. Next, the positive electrode 1003 and the negative electrode 1005 are collectively ejected and welded by ultrasonic waves, and are drawn as tabs 920 and 930 in FIG. 9, and lastly, the entire structure is packed with a laminate sheet 1010. Further, an electrolyte 1040 is injected and filled in the structure packed with the laminate sheet 1010, thereby obtaining a cell structure illustrated in FIG. 9. As the laminate sheet, for example, an aluminum foil with polyethylene coated on both sides thereof can be used. As the electrolyte, for example, an electrolyte obtained by melting lithium hexafluorophosphate (LiPF₆) in a diethyl carbonate organic solvent with a concentration of 1 mol/l can be used. In order to activate this cell, an appropriate voltage is applied between the tabs to thereby perform discharging and charging in several cycles. In this case, activation is performed while evacuating a gas discharge port 950 of a cell illustrated in FIG. 9 by a vacuum pump, thereby making it possible to effectively release gas generated from the positive electrode 1003 or the like to the outside of the bag-like separator 1001 through the slit and further to the outside of the cell. After the activation is finished, the gas discharge port 950 is sealed by heat-sealing and extra portions are cut off, thereby completing the final stacked secondary battery cell.

While preferred example embodiments of the present invention have been described above, the present invention is not limited to the example embodiments. For example, the direction of each slit need not necessarily be completely parallel to the contraction direction of each separator. The example embodiments described above illustrate a stacked secondary battery in which a positive electrode, which is one of the positive electrode and a negative electrode, is accommodated in a bag-like separator, and the negative electrode, which is another one of the positive electrode and the negative electrode, is stacked on the bag-like separator in which the positive electrode is accommodated. However, the present invention is not limited to this. Specifically, the stacked secondary battery is considered to have a structure in which a negative electrode, which is one of a positive electrode and the negative electrode, is accommodated in a bag-like separator, and the positive electrode, which is another one of the positive electrode and the negative electrode, is stacked on the bag-like separator in which the negative electrode is accommodated. It is also considered that the thickness of each separator at the overlapping portion between two sheets of separators is smaller than the thickness of the remaining portion of each separator. The present invention can be modified in various ways within the scope of the invention described in the claims, and needless to say, these modifications are included in the scope of the present invention.

The whole or part of the example embodiments described above can be described as, but not limited to, the following supplementary notes.

(Supplementary note 1) A stacked secondary battery including a positive electrode and a negative electrode, being stacked with a bag-like separator interposed therebetween, wherein one of the positive electrode and the negative electrode is accommodated in the bag-like separator; another of the positive electrode and the negative electrode is stacked on the bag-like separator in which the one electrode is accommodated; and the bag-like separator has a uniaxial contraction characteristic at a high temperature and includes a slit formed along a contraction direction with a high contraction coefficient.
(Supplementary note 2) The stacked secondary battery according to Supplementary note 1, wherein the bag-like separator has a rectangular shape with two sides thereof parallel to the contraction direction.
(Supplementary note 3) The stacked secondary battery according to Supplementary note 2, wherein a surrounding portion of the bag-like separator is formed by heat-sealing at least a part of a side substantially orthogonal to the contraction direction.
(Supplementary note 4) The stacked secondary battery according to Supplementary note 1, wherein the slit is formed of an overlapping portion between two sheets of separators constituting a part of the bag-like separator.
(Supplementary note 5) The stacked secondary battery according to Supplementary note 4, wherein the slit is formed of an overlapping portion between a first portion and a second portion, the first portion constituting a part of the bag-like separator, the second portion being adjacent to the first portion.
(Supplementary note 6) The stacked secondary battery according to Supplementary note 5, wherein the slit is further formed of an overlapping portion between the second portion and a third portion being adjacent to the second portion.
(Supplementary note 7) The stacked secondary battery according to any one of Supplementary notes 4 to 6, wherein at least a part of an overlapping portion between the two sheets of separators includes a heat-sealed portion.
(Supplementary note 8) The stacked secondary battery according to any one of Supplementary notes 4 to 7, wherein a thickness of each separator at an overlapping portion between the two sheets of separators is smaller than a thickness at a remaining portion of each separator.
(Supplementary note 9) The stacked secondary battery according to any one of Supplementary notes 1 to 8, wherein the one electrode accommodated in the bag-like separator includes a plurality of electrodes.
(Supplementary note 10) The stacked secondary battery according to Supplementary note 9, wherein the one electrode has a substantially rectangular shape, and the plurality of the one electrodes are accommodated in the bag-like separator in such a way that short sides of the rectangular shape are arranged substantially in parallel.
(Supplementary note 11) The stacked secondary battery according to Supplementary note 9, wherein the one electrode has a substantially rectangular shape, and the plurality of the one electrodes are accommodated in the bag-like separator in such a way that long sides of the rectangular shape are arranged substantially in parallel.
(Supplementary note 12) The stacked secondary battery according to Supplementary note 11, wherein the bag-like separator is heat-sealed at a location between the plurality of the one electrodes accommodated in the bag-like separator in such a way that long sides of the rectangular shape are arranged substantially in parallel.
(Supplementary note 13) The stacked secondary battery according to any one of Supplementary notes 9 to 12, wherein at least a part of an overlapping portion between the two sheets of separators at a location between the plurality of the one electrodes includes a heat-sealed portion.
(Supplementary note 14) A bag-like separator used for a stacked secondary battery wherein a positive electrode and a negative electrode are stacked, the bag-like separator having a uniaxial contraction characteristic at a high temperature, and including a slit formed along a contraction direction with a high contraction coefficient.
(Supplementary note 15) The bag-like separator according to Supplementary note 14, wherein the bag-like separator has a rectangular shape with two sides parallel to the contraction direction.
(Supplementary note 16) The bag-like separator according to Supplementary note 15, wherein a surrounding portion of the bag-like separator is formed by heat-sealing at least a part of a side substantially orthogonal to the contraction direction.
(Supplementary note 17) The bag-like separator according to Supplementary note 14, wherein the slit is formed of an overlapping portion between two sheets of separators.
(Supplementary note 18) The bag-like separator according to Supplementary note 17, wherein the slit is formed of an overlapping portion between a first portion and a second portion, the first portion constituting a part of a separator, the second portion being adjacent to the first portion.
(Supplementary note 19) The bag-like separator according to Supplementary note 18, wherein the slit is further formed of an overlapping portion between the second portion and a third portion being adjacent to the second portion.
(Supplementary note 20) The bag-like separator according to any one of Supplementary notes 17 to 19, wherein at least a part of an overlapping portion between the two sheets of separators includes a heat-sealed portion.
(Supplementary note 21) The bag-like separator according to any one of Supplementary notes 17 to 20, wherein a thickness of each separator at an overlapping portion between the two sheets of separators is smaller than a thickness at a remaining portion of each separator.

### INDUSTRIAL APPLICABILITY

According to the present invention, even when a positive electrode is formed of a material called a lithium-excess positive electrode material with which a capacity that is twice or more than that of the lithium-ion battery described in the Background Art is obtained, a cell whose performance can be sufficiently exerted and has a safe performance can be formed. Therefore, application examples of the present invention may include a long-range electric vehicle, a drone, a robot, or the like.

The present invention has been described above with reference to the above-described example embodiments as exemplary examples. However, the present invention is not limited to the above-described example embodiments. In other words, the present invention can be applied to various modes that can be understood by those skilled in the art within the scope of the present invention.

This application is based upon and claims the benefit of priority from Japanese Patent Application No. 2016-105071, filed on May 26, 2016, the disclosure of which is incorporated herein in its entirety by reference.

### REFERENCE SIGNS LIST

101, 1001 Separator
102, 102a, 502, 502a, 602, 602a, 702, 702a, 702b, 802, 802a Heat-sealed portion
103, 503, 603, 703, 803, 1003 Positive electrode
404 Positive-electrode-including bag-like separator
405, 1005 Negative electrode
910, 1010 Laminate sheet
920, 930 Tab
1040 Electrolyte
950 Gas discharge port
1160 Bubbles of generated gas

1. A stacked secondary battery comprising a positive electrode and a negative electrode, being stacked with a bag-like separator interposed therebetween, wherein
one of the positive electrode and the negative electrode is accommodated in the bag-like separator; another of the positive electrode and the negative electrode is stacked on the bag-like separator in which the one electrode is accommodated; and wherein
the bag-like separator has a uniaxial contraction characteristic at a high temperature and includes a slit formed along a contraction direction with a high contraction coefficient.

2. The stacked secondary battery according to claim 1, wherein the bag-like separator has a rectangular shape with two sides thereof parallel to the contraction direction.

3. The stacked secondary battery according to claim 2, wherein a surrounding portion of the bag-like separator is formed by heat-sealing at least a part of a side substantially orthogonal to the contraction direction.

4. The stacked secondary battery according to claim 1, wherein the slit is formed of an overlapping portion between two sheets of separators constituting a part of the bag-like separator.

5. The stacked secondary battery according to claim 4, wherein the slit is formed of an overlapping portion between a first portion and a second portion, the first portion constituting a part of the bag-like separator, the second portion being adjacent to the first portion.

6. The stacked secondary battery according to claim 5, wherein the slit is further formed of an overlapping portion between the second portion and a third portion being adjacent to the second portion.

7. The stacked secondary battery according to claim 4, wherein at least a part of an overlapping portion between the two sheets of separators includes a heat-sealed portion.

8. The stacked secondary battery according to claim 4, wherein a thickness of each separator at an overlapping portion between the two sheets of separators is smaller than a thickness at a remaining portion of each separator.

9. The stacked secondary battery according to claim 1, wherein the one electrode accommodated in the bag-like separator includes a plurality of electrodes.

10. The stacked secondary battery according to claim 9, wherein the one electrode has a substantially rectangular shape, and the plurality of the one electrodes are accommodated in the bag-like separator in such a way that short sides of the rectangular shape are arranged substantially in parallel.

11. The stacked secondary battery according to claim 9, wherein the one electrode has a substantially rectangular shape, and the plurality of the one electrodes are accommodated in the bag-like separator in such a way that long sides of the rectangular shape are arranged substantially in parallel.

12. The stacked secondary battery according to claim 11, wherein the bag-like separator is heat-sealed at a location between the plurality of the one electrodes accommodated in the bag-like separator in such a way that long sides of the rectangular shape are arranged substantially in parallel.

13. The stacked secondary battery according to claim 9, wherein at least a part of an overlapping portion between the two sheets of separators at a location between the plurality of the one electrodes includes a heat-sealed portion.

14. A bag-like separator used for a stacked secondary battery in which a positive electrode and a negative electrode are stacked, wherein
the bag-like separator has a uniaxial contraction characteristic at a high temperature, and includes a slit formed along a contraction direction with a high contraction coefficient.

15. The bag-like separator according to claim 14, wherein the bag-like separator has a rectangular shape with two sides parallel to the contraction direction.

16. The bag-like separator according to claim 15, wherein a surrounding portion of the bag-like separator is formed by heat-sealing at least a part of a side substantially orthogonal to the contraction direction.

17. The bag-like separator according to claim 14, wherein the slit is formed of an overlapping portion between two sheets of separators.

18. The bag-like separator according to claim 17, wherein the slit is formed of an overlapping portion between a first portion and a second portion, the first portion constituting a part of a separator, the second portion being adjacent to the first portion.

19. The bag-like separator according to claim 18, wherein the slit is further formed of an overlapping portion between the second portion and a third portion being adjacent to the second portion.

20. The bag-like separator according to claim 17, wherein at least a part of an overlapping portion between the two sheets of separators includes a heat-sealed portion.

21. (canceled)
